(19) United States
(12) Patent Application Publication
(10) Pub. No.: US 2012/0162666 A1
(43) Pub. Date: Jun. 28, 2012

(54) POSITION MARKING FOR IDENTIFYING A SURFACE REGION AND METHOD FOR IDENTIFYING/AUTHENTICATING ON THE BASIS OF THE MARKED SURFACE REGION

(75) Inventors: Markus Gerigk, Koln (DE); Andreas Bäcker, Wuppertal (DE); Thomas Birsztejn, Dormagen (DE); Ralf Imhäuser, Langenfeld (DE); Christian Roth, Leverkusen (DE); Walter Speth, Duren (DE); Simon Vougioukas, Pulheim (DE)

(73) Assignee: BAYER TECHNOLOGY SERVICES GMBH, LEVERKUSEN (DE)

(21) Appl. No.: 13/322,178

(22) PCT Filed: May 30, 2009
(86) PCT No.: PCT/EP2010/003025

§ 371 Date: Dec. 27, 2011

(30) Foreign Application Priority Data
May 30, 2009 (DE) 10 2009 023 536.1

(51) Int. Cl. G01B 11/14

(52) U.S. Cl. 356/614

(57) ABSTRACT

Position indicator which can be connected to an object and distinctly marks a designated region of a surface of the object such that said region can be clearly differentiated from other regions of the surface, and use of the position indicator for marking surfaces for the purpose of identification and/or authentication and to a method for detecting characteristic radiation

The invention relates to a position indicator which can be connected to an object and distinctly marks a designated region of a surface of the object such that said region can be clearly differentiated from other regions of the surface. The invention further relates to the use of the position indicator according to the invention for marking surfaces for the purpose of identification and/or authentication and to a method for detecting characteristic radiation patterns, preferably for the purpose of identification and/or authentication of an object.

The automatic detection of objects by means of optical methods is known according to the prior art. Everyone is familiar with, for example, goods and/or packaging being provided with barcodes which enable identification of the goods by way of machines in order to ascertain, for example, the price.

A known representative of the barcodes is the EAN 8 code which is defined in the international standard ISO/IEC 15420. It encodes a sequence of 8 digits in the form of bars and spaces of varying width. The bars are generally printed in black printing ink onto a white support, for example the packaging of the object to be marked or onto the object itself.

In addition to the EAN 8 code described, there are numerous other barcodes which also encode, in addition to digits, letters, special characters and control characters. One development of the barcodes is the 2D codes in which the information is optically encoded not just one-dimensionally but in two dimensions. A subgroup of the 2D codes is the so-called matrix codes. A known representative, for example, is the Data Matrix code which is defined in the international standard ISO/IEC 16022.

Machine-readable optical codes such as the abovementioned barcodes, 2D codes and Matrix codes, but also OCR text (OCR=Optical Character Recognition) or similar optically machine-readable codes will be grouped together in the following text under the generic term optical codes.

Optical codes can firstly be manufactured (printing) simply and extremely cost-effectively, and secondly can be optically detected, i.e. read, quickly and reliably. They are therefore ideally suited for identifying objects. Optical codes are suitable in particular for tracking objects (track & trace). In this case, an object is assigned, for example, a unique number with the result that the object can be identified at each station in the logistics chain and thus the movement of the object from one station in the logistics chain to another can be tracked.

However, optical codes do not afford protection against forgery, since they can be copied and reproduced in a simple manner.

For security against forgery, identity cards, banknotes, products, etc. are nowadays provided with elements which can be imitated only with special knowledge and/or high technical complexity. Such elements are referred to here as security elements. Security elements are preferably inseparably connected to the objects to be protected. The attempt to separate the security elements from the object preferably leads to their destruction, in order that the security elements cannot be misused.

The authenticity of an object can be checked on the basis of the presence of one or more security elements. The method for checking the authenticity of an object is referred to here as authentication.

Optical security elements such as e.g. watermarks, special inks, guilloche patterns, microscripts and holograms are established worldwide. An overview of optical security elements, which are suitable in particular but not exclusively for document protection, is given by the following book: Rudolf L. van Renesse, Optical Document Security, Third Edition, Artech House Boston/London, 2005 (pp. 63-259).

There are also methods for identifying and/or authenticating in which no other features are used beside those which are provided by the object itself.

WO2005/088533(A1) describes a method by which objects can be identified and authenticated on the basis of their characteristic surface structure. In this case, the method manages without additional means such as security elements, for example, which are connected to the objects. In the method, a laser beam is focused onto the surface of the object, and moved over the surface (scanning), and the beams scattered to different extents at different angles at different locations of the surface are detected by means of photodetectors. The scattering radiation detected is characteristic of a multiplicity of different materials and can be imitated only with very great difficulty, since it is attributable to random occurrences during the production of the object. By way of example, paper-like objects have a production-governed fibre structure that is unique for each object produced. The scattering data relating to the individual objects are stored in a database in order to be able to authenticate the object at a later point in time. For this purpose, the object is measured again and the scattering data are compared with the stored reference data.

The random features of the object that are used in the method in WO2005/088533(A1) bring about very high protection against forgery.

The method described in WO2005/088533(A1) comprises the steps of initial detection and repeat detection. In the initial detection, the characteristic scattering radiation of a defined surface region is measured. The measured scattering radiation is stored—e.g. in the form of a code on the object itself or as a data set in a database. In the repeat detection, the characteristic scattering radiation is recorded again and compared to one or more data sets of stored scattering radiation in order to identify the object or confirm the identity of the object.

In order to be able to employ the method described in WO2005/088533(A1) for identifying and authenticating objects, it must be ensured that the surface region in the repeat detection is the same as the surface region in the initial detection.

With increasingly larger objects, the number of selection options for the region for detection increases. WO2005/088533(A1) describes that distinct markings on the object can be used in order to distinctly define the detection region. Prominent points or boundaries of the object, such as an edge in a paper document, can also be used to define and determine the position of the detection region. Such prominent points, boundaries or markings are grouped together here and designated position indicators.

Ideally, position indicators are situated in the immediate vicinity of the detection region. If position indicator and detection region are spaced too far apart, it becomes increasingly difficult to determine the position of the detection region. There may be objects which are used as high-grade components in machines (e.g. in space travel or military technology) and which have position indicators. It is also conceivable, however, that the surface regions in the immediate vicinity of the position indicators are either not suitable for detecting characteristic scattering radiation at all or are covered in the completed machine. If that is so, it will be difficult to determine the position of the detection region.

There are also objects which have no distinct position indicators, such as flacons for high-quality perfume having rounded edges and corners. Such objects would either be excluded from the method described in WO2005/088533(A1), or the majority of the surface would have to be detected in the initial detection in order to achieve a high likelihood in a repeat detection that the detected region corresponds at least in part with the region of the initial detection.

It is likewise conceivable that paper-like objects which have a printed-on position indicator can lose said position indicator for example as a result of water damage. In such a case, the paper-like object would very likely still be accessible to the method described in WO2005/088533(A1), but the missing position indicator would complicate the process of identification and/or authentication. The same is true for a paper-like object in which an edge of the paper was used as a position indicator, which edge has frayed with time.

The larger the detected region, the larger also the amount of data recorded. The amount of data which can be stored in an optical code on the object itself is limited, however. With increasing amounts of data in databases, costs go up and, in the case of online access to the stored data sets in the course of detection, the speed of identification and/or authentication decreases. It would be advantageous for this reason if as small a detection region as possible were used. However, the smaller the detection region, the more difficult the exact determination of its position.

The method described in WO2005/088533(A1) accordingly represents a very secure anti-forgery method for identifying objects, but there are numerous restrictions in its practical use.

It would be desirable to be able to also use said method for objects which either have no position indicators or where potential position indicators are located far away from the detection region. It would be desirable to be able to use said method also for objects in which only those position indicators which can be easily damaged are present. It would be desirable if the method could also be employed for small detection regions without restrictions and without complicating the position determination as the size of the detection region decreases.

Starting from the prior art, the object thus arises of providing a solution for also making an object which is suitable in principle, on account of the nature of its surface or volume, for an identification and/or authentication based on characteristic radiation patterns accessible to such a method in practice, independent of its size, shape and nature.

It has surprisingly been found that this object can be achieved simply and efficiently by way of a position indicator which is connected to an object and which has a designated region which marks a surface region of the object in a terminating manner.

An object of the present invention is therefore a position indicator for placement on an object, at least comprising a marking region which marks a selected surface region of the object in a terminating manner.

Marking a surface region in a terminating manner is understood to mean that a region of the surface of an object is accentuated by means of the position indicator according to the invention and delimited with respect to other surface regions such that said surface region is clearly distinguishable from all other surface regions and that there is no surface region for which there is any doubt as to whether or not it belongs to the marked surface region.

The position indicator accordingly marks, by means of a marking region, a region of the surface of an object, which region is intended to be used for detecting a characteristic radiation pattern. It is conceivable that the position indicator according to the invention comprises more than one marking region.

Detecting a characteristic radiation pattern is understood to mean a method in which a region of an object is irradiated using electromagnetic radiation and the radiation emanating from the object is received by means of suitable detectors and converted into a storable signal. The radiation which is used to irradiate the object will be referred to as input signal and the radiation which emanates from the object will be referred to as output signal in the following text. It is conceivable that the output radiation is reflected and/or scattered radiation. In such a case, the detection of the characteristic radiation pattern is effected in reflection, that is to say the source for the input signal and detectors for the output signal are located on the same side as viewed from the object. It is likewise conceivable for the detection of the output signal to be effected in transmission, that is to say the source for the input signal and detectors for the output signal are located on different sides of the object as viewed from the object, and parts of the input signal and the output signal must pass through part of the object. Examples of detecting characteristic radiation patterns will be discussed further below.

The position indicator has at least one area which can be brought into contact with positive fit with part of the surface of an object. Since the surface region of an object is preferably configured in a planar manner for detection of a characteristic radiation pattern, the position indicator according to the invention also has at least one planar area.

The marking region of the position indicator according to the invention is preferably in the form of a cut-out. The position indicator accordingly comprises an area which can be brought into contact with part of the surface of an object and which has a cut-out which marks that surface region of the object in a distinct and terminating manner which is located in the region of the cut-out between position indicator and object in the case of contact.

The surface of the position indicator according to the invention preferably shows a different behaviour when irradiating with electromagnetic radiation from the marked surface region of the object. For example, if the object is a paper-like object which scatters, in the case of irradiation with electromagnetic radiation, the latter in a wide angle range, then the surface of the position indicator is preferably either designed in a specular manner or configured such that the radiation which is radiated in is completely, or virtually completely, absorbed. The advantage of this is that if possible no or little radiation which could lead to an increase in the signal-to-noise ratio when detecting the characteristic radiation pattern emanates from the position indicator itself.

In one preferred embodiment, the position indicator according to the invention comprises a layer which is at least partially transparent for the input signal. Said layer will be referred to as a transparent layer below. If the output signal is measured in reflection, the transparent layer is also at least partially transparent for the output signal.

The transparent layer comprises or contains the marking region. The use of a transparent layer has the advantage that the surface region for detection is protected by the transparent layer against damage by environmental influences, such as dust, scratches, moisture and the like. The marked surface region is covered by the transparent layer but remains accessible moreover to the detection of characteristic radiation patterns due to the transparency.

The position indicator preferably has means for connecting to part of the surface of an object. In one preferred embodiment, the position indicator is in the form of for example a self-adhesive label, i.e. it has an adhesive layer which connects the position indicator and the object in the case of contact with part of the surface of an object.

The connection between position indicator and object can be designed to be detachable or non-detachable. A detachable connection is a connection which can be detached without leaving visual traces of the previous connection on the object or on the position indicator. A non-detachable connection is a connection in which the object and/or the position indicator suffer(s) damage when an attempt is made to remove the connection. If the non-detachable connection was detached by force, unambiguous visual traces are left behind on the position indicator and/or on the object which indicate an attempted detachment.

The position indicator can have further features. In one preferred embodiment, the position indicator has at least one optical code. The optical code can contain, for example, information relating to the identity of the object. By way of example, it can contain the characteristic radiation pattern of the marked surface region in digital form. It is thus possible to considerably speed up the process of identifying the object. If it is not known what the object is in any respective case, it would be necessary to compare the characteristic radiation pattern of the object with all the radiation patterns of objects which are stored in a database in order to identify that object whose radiation pattern is the closest match to that of the object in case (so-called 1:n comparison if there is a number n of radiation patterns). If the identity of an object can already be ascertained by the optical code, only its genuineness needs to be checked in a so-called 1:1 comparison with the currently detected radiation pattern of the object in case. The 1:1 comparison requires significantly less time than a 1:n comparison with a number n of radiation patterns which are present, with n>>1.

The position indicator according to the invention can have any desired shape; by way of example, it may be round, elliptic, oval or n-angular. The size of the position indicator according to the invention is preferably between 10 mm² and 10 000 mm².

The position indicator according to the invention is suitable for marking a surface region in a terminating manner. Thus, the object of the present invention is also the use of the position indicator for marking a surface region of an object in a terminating manner. To this end, the position indicator according to the invention is connected to the object detachably or non-detachably. In one preferred embodiment, the position indicator is connected to the object in a non-detachable manner. In this preferred embodiment, the position indicator preferably acts as a security element at the same time. By trying to remove the position indicator from the object, the position indicator is rendered useless. The position indicator can comprise further security features in order to further increase the security against falsification, such as watermarks, special inks, guilloche patterns, microscripts and/or holograms.

Various features and their combination can render the connection between position indicator and object non-detachable. By way of example, it is conceivable to introduce a separation layer within the position indicator. The adhesive layer for adhesively bonding to an object and the separation layer are matched to one another such that the forces which hold the separation layer together are weaker than the forces which hold together the position indicator and the object via the adhesive layer. By trying to remove the position indicator from the object, it is thus more likely that the separation layer comes apart than that the adhesive layer is detached from the object. The separation layer thus forms a predetermined breaking point.

Another feature which indicates an attempted detachment are for example substances which experience irreversible colour change if a determined temperature limit is exceeded and/or undershot. It is known that adhesive layers can exert their adhesive force only within a limited temperature range (effective adhesive range). At low temperatures, the adhesive can become brittle and thus fragile; at high temperatures, the adhesive can soften. This makes it possible for a potential forger, by means of a temperature change above or below the range in which the adhesive layer is effective, to perform a detachment of the position indicator from the object. Therefore, such an attempt in the case of the security element according to the invention leads to an irreversible visible alteration of the security element, which indicates the attempted attack. Preferably, the irreversible colour change occurs at least 5 kelvins below the upper temperature limit of the effective adhesive range and/or at least 5 kelvins above the lower temperature limit of the effective adhesive range.

The introduction of stamped portions can also prevent reversible detachment of the position indicator from the object by resulting in a division of the position indicator when detachment is attempted. Forces, which act on the position indicator when detachment is attempted are channelled in a deliberate manner by way of the stamped portions and result in its division. The division is preferably irreversible, which can be achieved e.g. by virtue of the stamped portions not leading through all the layers of the position indicator, such that in the event of a division, a layer in which no stamped portion is present experiences an irreversible, recognizable separation (destruction) as a result of the division.

The position indicator is preferably used in order to distinctly accentuate the region of a surface which is intended to be used for detecting characteristic radiation patterns. Characteristic radiation patterns are preferably detected in order to identify and/or authenticate an object. To this end, the object is designed such that in the case of irradiation with an input signal a characteristic output signal emanates from the object, which output signal can be used for the distinct detection of the object (identification) and/or for monitoring the identity of the object (authentication).

Another object of the present invention is thus a method for detecting characteristic radiation patterns, preferably for the purposes of identification and/or authentication of an object, at least comprising the following steps:
(A) placing a position indicator on an object, wherein the position indicator marks a surface region of the object in a distinct and terminating manner,
(B) irradiation of the marked surface region with electromagnetic radiation,
(C) detection of radiation emanating from the object,
(D) determination and storing of a characteristic radiation pattern on the basis of the detected radiation.

Placement in step (a) can be effected, depending on the embodiment of the position indicator and of the object, by way of a technique, known to the person skilled in the art, for connecting articles, for example by way of adhesive bonding, laminating, welding, soldering or other techniques.

Irradiation in step (B) is effected, depending on the nature of the object, with polychromatic or monochromatic radiation in a wavelength range in which the object produces a characteristic radiation pattern in the case of irradiation. The form of the radiation profile (point, line or area irradiation) is likewise matched to the object and to the nature of the characteristic radiation pattern.

If the random surface nature of an object is used with the method described in WO2005/088533(A1) for identification and/or authentication of the object, the marked surface region is scanned preferably by means of monochromatic radiation with a linear beam profile. If the object has metal marking platelets, such as described, for example, in WO2009/036878(A1), their random distribution and/or orientation can be used for the identification and/or authentication of the object. To this end, the object can be irradiated by means of polychromatic electromagnetic radiation in a wavelength range in which the metal marking platelets are reflective. The irradiation is preferably effected in the form of a scan by means of a linear beam profile. Details can be found in the application PCT/EP2009/000450.

If the object has randomly distributed luminescent nanoparticles, as are described, for example, in US2007/0054120A1, their distribution in the object can be used for the identification and/or authentication. The object can, by way of example, be illuminated in an areal manner by means of radiation with the excitation wavelength.

The detection of the characteristic radiation pattern in step (C) and the derivation and storage of a characteristic radiation pattern in step (D) occur as a function of the nature of the object and of the radiation emanating from the object. Reference is made here in the individual case to the respective methods for detecting the characteristic radiation pattern (see correspondingly e.g. WO2009/036878(A1), PCT/EP2009/000450, US2007/0054120A1).

Typically, photodetectors which convert incident electromagnetic radiation into an electric signal are used to detect radiation. Examples of photodetectors are photodiodes, phototransistors and CCD sensors (CCD=charge-coupled device).

The electric signal can then if appropriate after an analogue-to-digital conversion be stored in a database as a digital file or be printed onto the object or the position indicator in the form of an optical code.

The later identification and/or authentication of the object comprise(s) at least the following steps:
(a) irradiation of the marked surface region with electromagnetic radiation,
(b) determination of a characteristic radiation pattern on the basis of the detected radiation,
(c) comparison of the characteristic radiation pattern with at least one radiation patterns which was detected and stored at an earlier point in time,
(d) outputting a message relating to the identity/authenticity of the object as a function of the result of the comparison in step (c).

The identification and/or authentication of an object is/are preferably effected by way of a machine.

What was already written above for steps (B), (C) and (D) applies to steps (a) and (b).

It is necessary for the comparison in step (c) that the characteristic radiation pattern generally does not correspond 100% to a radiation pattern which was ascertained at an earlier point in time. The reason for this is, for example, that the surface of the object is subjected to an ageing process and the characteristic radiation pattern changes as a result of environmental influences. Typically, a threshold value S is thus defined. If the degree of correspondence between the characteristic radiation pattern and a radiation pattern which was ascertained at an earlier point in time is e.g. S or above, a correspondence is regarded as given; if the degree of correspondence is below S, the comparing data sets are regarded as different.

The radiation patterns are typically present in machine-processable form, i.e. for example as a number table. The data sets can be compared on the basis of the complete number table or on the basis of characteristic features from the number table. For this purpose, for example, known methods of pattern matching can be used, in which a search is carried out for similarities between the data sets (see, e.g., Image Analysis and Processing: 8th International Conference, ICIAP '95, San Remo, Italy, Sep. 13-15, 1995. Proceedings (Lecture Notes in Computer Science), WO 2005/088533(A1), WO2006/016114(A1), C. Demant, B. Streicher-Abel, P. Waszkewitz, Industrielle Bildverarbeitung, Springer-Verlag, 1998, pages 133 ff, J. Rosenbaum, Barcode, Verlag Technik Berlin, 2000, pages 84 ff, U.S. Pat. No. 7,333,641 B2, DE10260642 A1, DE10260638 A1, EP1435586B1).

In step (d), a message is output relating to the identity and/or authenticity of the object as a function of the result of the comparison in step (c).

In step (d), a notification can occur, for example, relating to whether the object is an authentic object or a forgery. A light signal can be used for this, for example: if the data sets compared in step (c) are considered to correspond, it is obviously not a forgery and, for example, a green light flashes; if the data sets compared in step (c) are considered not to correspond, it is obviously a forgery and, for example, a red light flashes. As an alternative, an acoustic signal or another notification which can be detected by the human senses is also conceivable. Furthermore, the degree of correspondence can be output via a printer, monitor or the like.

The invention will be explained in further detail below using figures and examples, without however, being limited thereto.

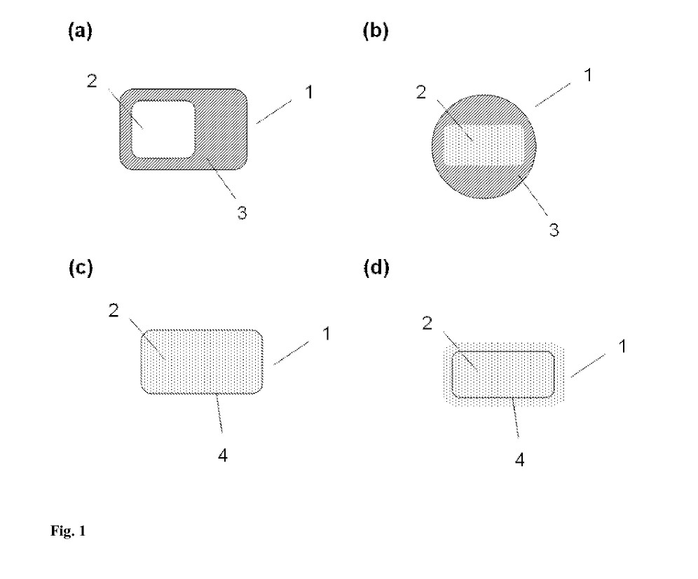

FIGS. 1(a), (b), (c) and (d) show schematically preferred embodiments of the position indicator according to the invention. All the embodiments are shown in plan view.

FIG. 1(a) shows a position indicator 1 comprising a cut-out which represents the marking region 2. By placing the position indicator on an object, that surface region of the object which is located within the marking region 2 is accentuated and marked in a distinct and terminating manner.

FIG. 1(b) shows a position indicator 1 which has as the marking region 2 a transparent layer. By placing the position indicator on an object, that surface region of the object which is located underneath the marking region 2 is accentuated and marked in a distinct and terminating manner. At the same time, it is protected against harmful environmental influences.

The surface 3 of the position indicators in FIGS. 1(a) and 1(b) is preferably configured such that they, in the case of irradiation with electromagnetic radiation, output no or as different a signal as possible than the surface region of the object which the position indicators mark.

FIG. 1(c) shows a position indicator 1 which is designed as a transparent layer composite. A line marking which can be realized via a print marks the outer frame of the layer composite. By placing the position indicator on an object, that surface region of the object which is located underneath the layer composite and within the marking 4 is accentuated and marked in a distinct and terminating manner. At the same time, it is protected against harmful environmental influences. In the example in FIG. 1(d), the marking is not placed in the outer region of the layer composite but marks a delimited region within the position indicator.

A film, for example, of biaxially oriented polyester, which is provided with an adhesive layer, can be used as the layer composite. Such films are sold for example under the trademark Tesa®-Film by tesa SE.

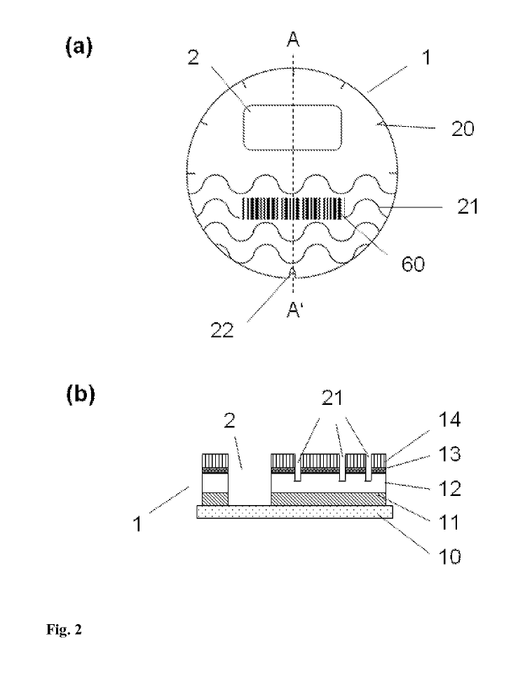

FIGS. 2(a) and (b) show schematically a preferred embodiment of the position indicator according to the invention which is configured as a self-adhesive label.

FIG. 2(a) shows a plan view of the position indicator, and FIG. 2(b) shows a cross section thereof through the dashed line between points A and A′, which line is shown in FIG. 2(a).

The position indicator has three types of stamped portions: radial stamped security portions 20 in the edge region of the position indicator, wave-type stamped security portions 21 which extend over the position indicator, and a stamped external contour portion 22 in the edge region.

The position indicator furthermore has an optical code in which details relating to the identity of the object can be stored.

The position indicator is in the form of a layer composite. The layer sequence, starting with the lowermost layer, is: an adhesive protection layer 10, an adhesive layer 11, a layer comprising a fibrous material 12, a printing layer 13 and a protective layer 14. In the present case, the fibrous material layer 12 fulfils not only the function of providing a predetermined breaking point in the event of a detachment attempt (separation layer) but also the function of receiving the printing ink (printing layer).

The layer sequence shown in FIG. 2(b) can be implemented by way of example as follows: the lower region is formed by the special paper 7110 from 3M (3M 7110 litho paper, white). This special paper is a composite material which already comprises the layer sequence adhesive protection layer, adhesive layer and fibrous material layer. The adhesive layer is a strongly adhering acrylate adhesive whose adhesive force with respect to the substrate (e.g. polyethylene or polypropylene), according to the manufacturer's information, is higher than the strength of the fibrous material layer. The fibrous material layer thus acts as a separation layer that tears in the event of a detachment attempt.

The special paper 7110 is temperature-resistant within the range from −40° C. to 175° C. The matt surface enables printing and thus provides the surface for printing with an optical code (and further printing images, if appropriate).

A primer on the special paper 7110 (e.g. Indigo Topaz 10 Solution MPS-2056-42 by Hewlett Packard) can be used for improved adherence of the printing ink. A colour change layer and a printing layer can be applied to the primer by means of known printing techniques (e.g. digital printing). ThermaFlag W/B from the manufacturer Flexo&Gravure Ink is suitable for example as the colour change layer that brings about an irreversible change in colour from transparent to black in the event of a temperature of approximately 120° C. being exceeded. The change ink is preferably printed on only in the code region. The optical code is printed onto the change ink by means of known printing techniques (e.g. digital printing). The termination of the composite is formed by a protective layer, e.g. the laminate PET Overlam RP35 from UPM Raflatac, which can be applied by means of known laminating methods.

### REFERENCE SIGNS

1 position indicator
2 marking region
3 surface of the position indicator
4 line marking
10 adhesive protection layer
11 adhesive layer
12 fibrous material layer
13 printing layer
14 protective layer
20 radial stamped security portion
21 wave-type stamped security portion
22 stamped external contour portion
60 optical code

1. Position indicator for placement on an object, comprising at least one area which can be brought into contact with positive fit with part of the surface of an object, and a marking region which marks a selected surface region of the object in a terminating manner.

2. Position indicator according to claim 1, wherein the marking region is in the form of a cut-out.

3. Position indicator according to claim 1, wherein the marking region is in the form of a transparent layer which is at least partially transparent at least for a partial range of electromagnetic radiation.

4. Position indicator according to claim 1, comprising means for connecting the position indicator to an object.

5. Position indicator according to claim 1 in the form of a self-adhesive label.

6. Position indicator according to claim 1, wherein, except for the marking region, it is designed in a specular manner.

7. Position indicator according to claim 1, wherein, except for the marking region, it predominantly absorbs electromagnetic radiation in the range of visible light.

8. Method for marking a surface region of an object in a terminating manner, which comprises marking said surface region with the position indicator of claim 1.

9. Method according to claim 8, wherein the position indicator is detachably connected to the object.

10. Method according to claim 8, wherein the position indicator is non-detachably connected to the object.

11. Method for detecting characteristic radiation patterns comprising the following steps:
(A) placing a position indicator on an object, wherein the position indicator marks a surface region of the object in a distinct and terminating manner,
(B) irradiation of the marked surface region with electromagnetic radiation,
(C) detection of radiation emanating from the object,
(D) determination and storing of a characteristic radiation pattern on the basis of the detected radiation.
